(19) United States
(12) Patent Application Publication
(10) Pub. No.: US 2017/0008167 A1
(43) Pub. Date: Jan. 12, 2017

(54) PIEZOELECTRIC DRIVE DEVICE, ROBOT, AND METHOD FOR DRIVING PIEZOELECTRIC DRIVE DEVICE

(71) Applicant: Seiko Epson Corporation, Tokyo (JP)

(72) Inventors: Yutaka ARAKAWA, Hara (JP); Tomohisa IWAZAKI, Matsumoto (JP)

(21) Appl. No.: 15/204,200

(22) Filed: Jul. 7, 2016

(30) Foreign Application Priority Data
Jul. 8, 2015 (JP) 2015-136780

(51) Int. Cl. B25J 9/12; H02N 2/00

(52) U.S. Cl. CPC B25J 9/12; H02N 2/001; H02N 2/006; H02N 2/009

(57) ABSTRACT

A piezoelectric drive device includes: a piezoelectric vibrating portion including a vibrating body, a piezoelectric element disposed on at least one surface of the vibrating body, and a support portion supporting the vibrating body; an elastic member pressing the vibrating body against a driven member; and a heat conducting member disposed so as to be capable of changing a mutual positional relationship with the elastic member while maintaining a surface-to-surface contact state therewith.

### BACKGROUND

1. Technical Field

The present invention relates to a piezoelectric drive device, a robot, and a method for driving a piezoelectric drive device.

2. Related Art

Piezoelectric actuators (piezoelectric drive devices) that vibrate a piezoelectric body to drive a driven body are used in various fields because a magnet or a coil is not necessary (e.g., JP-A-8-237971). A basic configuration of this piezoelectric drive device is a configuration in which four piezoelectric elements are disposed in two rows and two columns on each of two surfaces of a reinforcing plate, and the piezoelectric drive device is coupled to a housing with springs.

When the piezoelectric drive device is driven, a periodic voltage is applied to the piezoelectric body. Therefore, the piezoelectric body generates heat, which heats the piezoelectric drive device. However, in the piezoelectric drive device in the related art, sufficient consideration is not given to heat dissipation.

### SUMMARY

An advantage of some aspects of the invention is to solve at least a part of the problem described above, and the invention can be implemented as the following aspects or application examples.

(1) According to an aspect of the invention, a piezoelectric drive device is provided. This piezoelectric drive device includes: a piezoelectric vibrating portion including a vibrating body, a piezoelectric element disposed on at least one surface of the vibrating body, and a support portion supporting the vibrating body; an elastic member pressing the vibrating body against a driven member; and a heat conducting member disposed so as to be capable of changing a mutual positional relationship with the elastic member while maintaining a surface-to-surface contact state therewith. According to this aspect, by the use of the heat conducting member disposed so as to be capable of changing the mutual positional relationship with the elastic member while maintaining the surface-to-surface contact state therewith, the heat of the piezoelectric drive device (piezoelectric vibrating portion) can be easily dissipated.

(2) In the piezoelectric drive device of the aspect, the piezoelectric drive device may further include an intermediate member located between the vibrating body and the elastic member, the intermediate member being in contact with the support portion and not in contact with the piezoelectric element disposed on the vibrating body. According to the aspect with this configuration, the heat of the piezoelectric drive device (piezoelectric vibrating portion) can be easily dissipated through the intermediate member.

(3) In the piezoelectric drive device of the aspect, the elastic member may be in contact with the support portion and may not be in contact with the piezoelectric element on the vibrating body. According to the aspect with this configuration, the heat of the piezoelectric drive device (piezoelectric vibrating portion) can be easily dissipated through the elastic member.

(4) In the piezoelectric drive device of the aspect, the elastic member may be in contact with the heat conducting member at a surface on the side opposite to the surface in contact with the piezoelectric vibrating portion. According to the aspect with this configuration, in the elastic member, the heat can be easily moved from the surface in contact with at least one of the piezoelectric element and the vibrating body to the surface on the opposite side.

(5) In the piezoelectric drive device of the aspect, the piezoelectric drive device may further include a housing accommodating the vibrating body, the piezoelectric element, the support portion, and the elastic member, and the heat conducting member may constitute a portion of the housing. According to the aspect with this configuration, a separate heat dissipation structure is not necessary.

(6) In the piezoelectric drive device of the aspect, a thermal conductivity of the heat conducting member may be 0.1 W/mK or more. According to the aspect with this configuration, resin, which is low cost, can be used as the heat conducting member.

(7) In the piezoelectric drive device of the aspect, a thermal conductivity of the heat conducting member may be 10 W/mK or more. According to the aspect with this configuration, a metal material such as stainless steel having a high thermal conductivity can be used as the heat conducting member.

(8) In the piezoelectric drive device of the aspect, the heat conducting member may contain silicon. The thermal conductivity of silicon is about 170 W/mK, which allows more heat to move and be dissipated.

(9) In the piezoelectric drive device of the aspect, the vibrating body and the support portion may contain the same material and be integrated together. According to the aspect with this configuration, since the vibrating body and the support portion are formed integrally from the same material, the heat can be easily moved from the vibrating body to the support portion.

(10) According to an aspect of the invention, a robot is provided. This robot includes: a plurality of link portions; a joint connecting the plurality of link portions together; and the piezoelectric drive device according to any of the aspects, which rotates the plurality of link portions with the joint. According to this aspect, the piezoelectric drive device can be used to drive the robot.

(11) According to an aspect of the invention, a method for driving the piezoelectric drive device of the aspect is provided. This driving method includes applying, to the piezoelectric element, a pulsating voltage that periodically changes and in which a direction of an electric field to be applied to a piezoelectric body of the piezoelectric element is one direction. According to this aspect, since the direction of the voltage to be applied to the piezoelectric body of the piezoelectric element is only one direction, the durability of the piezoelectric body can be improved.

The invention can be implemented in various aspects. For example, in addition to the piezoelectric drive device, the invention can be implemented in various aspects such as a method for driving a piezoelectric drive device, a method for manufacturing a piezoelectric drive device, a robot in which a piezoelectric drive device is mounted, a method for driving a robot in which a piezoelectric drive device is mounted, an electronic component conveying apparatus, a liquid feed pump, and a dosing pump.

### BRIEF DESCRIPTION OF THE DRAWINGS

The invention will be described with reference to the accompanying drawings, wherein like numbers reference like elements.

FIG. 1 is a perspective view of a piezoelectric drive device.

FIG. 2 is an exploded perspective view of the piezoelectric drive device.

FIGS. 3A and 3B are explanatory views showing a schematic configuration of a piezoelectric vibrating portion.

FIG. 4 is a plan view showing a substrate and a wiring pattern formed on the substrate.

FIG. 5 is an explanatory view showing an equivalent circuit of the piezoelectric drive device.

FIG. 6 is an explanatory view showing an example of the operation of the piezoelectric vibrating portion.

FIG. 7 is an explanatory view showing a flowchart showing a film forming process performed in the manufacturing process of the piezoelectric vibrating portion.

FIG. 8 is an explanatory view illustrating the manufacturing process of the piezoelectric vibrating portion.

FIG. 9 is an explanatory view showing patterns of a wiring electrode.

FIGS. 10A to 10C are explanatory views each showing a configuration example in which a plurality of piezoelectric vibrating portions are stacked.

FIG. 11 is an explanatory view showing a configuration of an outer frame.

FIGS. 12A to 12D are explanatory views showing a configuration of an intermediate member.

FIG. 13 is an explanatory view showing a configuration of an inner frame.

FIG. 14 is an explanatory view showing a configuration of a plate spring.

FIG. 15 is an explanatory view showing a configuration of a fixing frame.

FIG. 16 is an explanatory view showing a configuration of a lid.

FIG. 17 is an explanatory view showing the movement of heat in the piezoelectric vibrating portion.

FIG. 18 is an explanatory view showing the movement of heat in the piezoelectric drive device.

FIGS. 19A to 19C are explanatory views showing piezoelectric vibrating portions as other embodiments.

FIG. 20 is an explanatory view showing an example of a robot.

FIG. 21 is an explanatory view of a wrist portion of the robot.

FIG. 22 is an explanatory view showing an example of a liquid feed pump.

### DESCRIPTION OF EXEMPLARY EMBODIMENTS

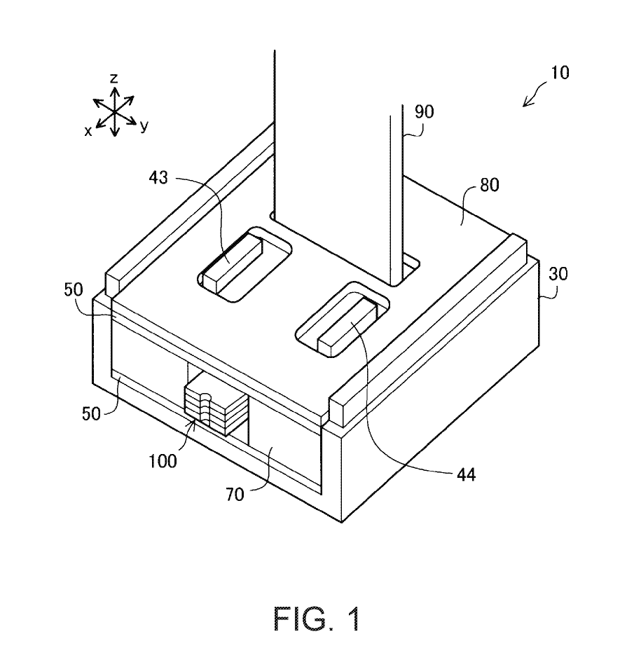

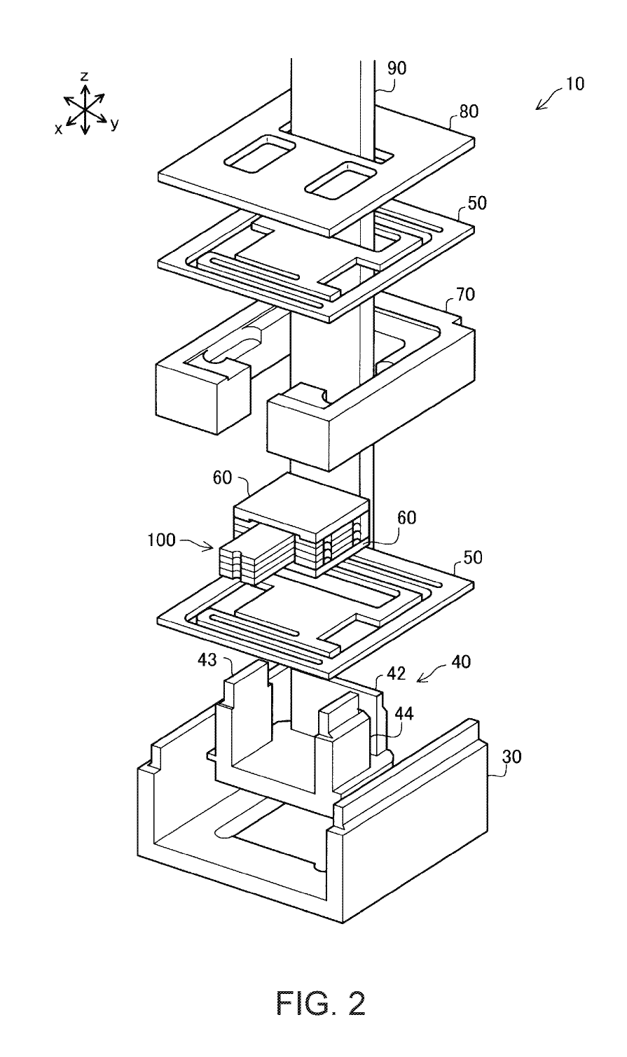

FIG. 1 is a perspective view of a piezoelectric drive device 10. FIG. 2 is an exploded perspective view of the piezoelectric drive device 10. The piezoelectric drive device 10 includes a plurality of piezoelectric vibrating portions 100, an outer frame 30, an inner frame 40, plate springs 50, intermediate members 60, a fixing frame 70, a lid 80, and a flexible substrate 90. The members are disposed as follows. The plurality of piezoelectric vibrating portions 100 are stacked in the z direction. There are two intermediate members 60, which interpose the plurality of piezoelectric vibrating portions 100 therebetween in the vertical direction (the z direction) as shown in FIG. 2. The intermediate members 60 interpose only a portion of the surface of the piezoelectric vibrating portion 100 therebetween. This will be described later. The fixing frame 70 surrounds the piezoelectric vibrating portions 100 and the intermediate members 60 in the x direction and the y direction. The two plate springs 50 interpose the intermediate members 60, the piezoelectric vibrating portions 100, and the fixing frame 70 therebetween in the vertical direction (the z direction). The inner frame 40 includes three side face portions 42, 43, and 44. These side face portions 42, 43, and 44 penetrate the plate springs 50, and are inserted between the piezoelectric vibrating portions 100 and the fixing frame 70. The outer frame 30 surrounds the fixing frame 70. The lid 80 is disposed on (the z direction) the plate spring 50 on the upper side. The flexible substrate 90 penetrates the lid 80 and the plate springs 50, and are connected to the piezoelectric vibrating portions 100. The structures of the members will be described below.

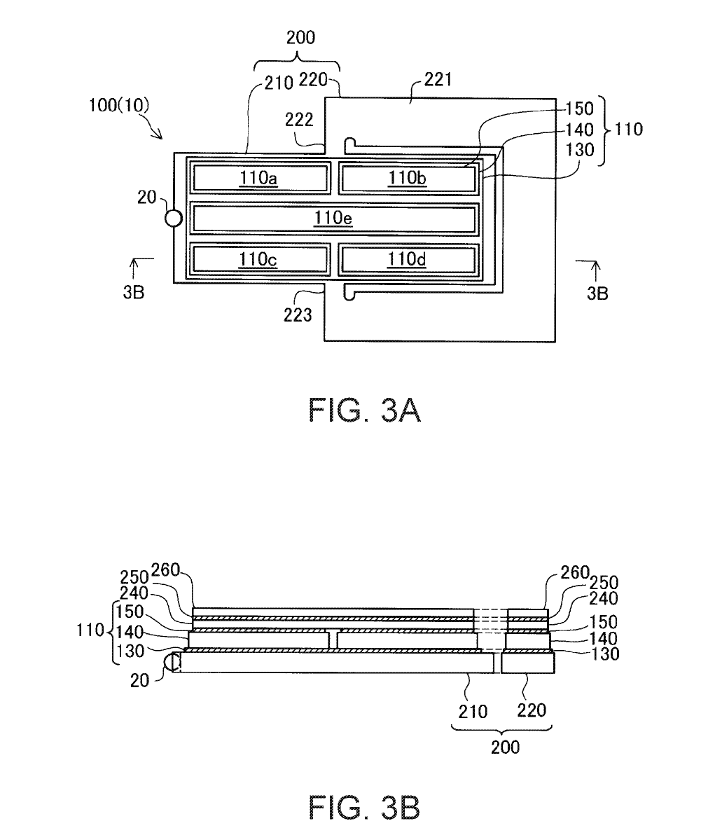

FIGS. 3A and 3B are explanatory views showing a schematic configuration of the piezoelectric vibrating portion 100, in which FIG. 3A is a plan view and FIG. 3B is a cross-sectional view along 3B-3B of FIG. 3A. In the plan view shown in FIG. 3A, an insulating layer 240, a wiring electrode 250, and a protective film 260 shown in FIG. 3B are omitted.

The piezoelectric vibrating portion 100 includes a substrate 200, a piezoelectric element 110, the insulating layer 240, the wiring electrode 250, and the protective film 260. The substrate 200 includes a vibrating body 210 and a support portion 220. The vibrating body 210 and the support portion 220 are connected at the middle of the long side of the vibrating body 210. In the support portion 220, edge portions connected with the vibrating body 210 are referred to as “first connecting portion 222” and “second connecting portion 223”; and a portion other than the first connecting portion 222 and the second connecting portion 223 is referred to as “fixed portion 221”. When the first connecting portion 222 and the second connecting portion 223 are not distinguished from each other, the “first connecting portion 222” and the “second connecting portion 223” are also referred to as “connecting portion 222” and “connecting portion 223”, respectively. The piezoelectric element 110 is formed on the substrate 200. The insulating layer 240, the wiring electrode 250, and the protective film 260 are formed on the piezoelectric element 110.

The piezoelectric element 110 includes a first electrode 130 (also referred to as “first electrode film 130” because it is formed into a film), a piezoelectric body 140 (also referred to as “piezoelectric body film 140” because it is formed into a film) formed on the first electrode 130, and a second electrode 150 (also referred to as “second electrode film 150” because it is formed into a film) formed on the piezoelectric body 140. The first electrode 130 and the second electrode 150 interpose the piezoelectric body 140 therebetween. The first electrode 130 or the second electrode 150 is a thin film formed by, for example, sputtering. As the material of the first electrode 130 or the second electrode 150, for example, any material having high conductivity, such as Al (aluminum), Ni (nickel), Au (gold), Pt (platinum), Ir (iridium), or Cu (copper), can be used.

The piezoelectric body 140 is formed by, for example, a sol-gel method or sputtering method, and has a thin film shape. As the material of the piezoelectric body 140, any material exhibiting a piezoelectric effect, such as ceramics having an ABO₃-type perovskite structure, can be used. As the ceramics having an ABO₃-type perovskite structure, for example, lead zirconate titanate (PZT), barium titanate, lead titanate, potassium niobate, lithium niobate, lithium tantalate, sodium tungstate, zinc oxide, barium strontium titanate (BST), strontium bismuth tantalate (SBT), lead metaniobate, lead zinc niobate, lead scandium niobate, or the like can be used. Moreover, a material exhibiting a piezoelectric effect other than ceramic, for example, polyvinylidene fluoride, quartz crystal, or the like can also be used. The thickness of the piezoelectric body 140 is, for example, preferably in the range of from 50 nm (0.05 μm) to 20 μm. The thin film of the piezoelectric body 140 having a thickness in this range can be easily formed using a film forming process (also referred to as “deposition process”). When the thickness of the piezoelectric body 140 is 0.05 μm or more, sufficiently large power can be generated in response to expansion or contraction of the piezoelectric body 140. When the thickness of the piezoelectric body 140 is 20 μm or less, the piezoelectric vibrating portion 100 can be sufficiently miniaturized.

In the embodiment, the piezoelectric vibrating portion 100 includes, as the piezoelectric element 110, five piezoelectric elements 110a, 110b, 110c, 110d, and 110e. The piezoelectric element 110e is formed into a substantially rectangular shape, and formed along the longitudinal direction of the vibrating body 210 in the middle of the vibrating body 210 in the width direction thereof. The piezoelectric elements 110a, 110b, 110c, and 110d are formed in the positions of four corners of the vibrating body 210. In FIGS. 3A and 3B, an example in which the piezoelectric element 110 is formed on one surface of the vibrating body 210; however, the piezoelectric element 110 may be formed on two surfaces of the vibrating body 210. In this case, the piezoelectric elements 110a to 110e on one surface and the piezoelectric elements 110a to 110e on the other surface are preferably disposed in symmetrical positions with respect to the vibrating body 210 as a symmetrical plane.

The substrate 200 is used as a substrate for forming the first electrode 130, the piezoelectric body 140, and the second electrode 150 by the film forming process. Moreover, the vibrating body 210 of the substrate 200 has also a function as a vibrating plate that performs mechanical vibration. The substrate 200 can be formed of, for example, Si, Al₂O₃, ZrO₂, or the like. As the substrate 200 made of Si (also referred to as “silicon substrate 200”), for example, a Si wafer for semiconductor manufacture can be used. The thickness of the substrate 200 is, for example, preferably in the range of from 10 to 100 μm. When the thickness of the substrate 200 is 10 μm or more, the substrate 200 can be relatively easily handled in a process of deposition on the substrate 200. When the thickness of the substrate 200 is 50 μm or more, the substrate 200 can be more easily handled. When the thickness of the substrate 200 (the vibrating body 210) is 100 μm or less, the vibrating body 210 can be easily vibrated in response to expansion or contraction of the piezoelectric body 140 formed of a thin film.

In the embodiment, the first electrode 130, the piezoelectric body 140, the second electrode 150, the insulating layer 240, the wiring electrode 250, and the protective film 260 are formed also on the support portion 220. As a result, the thickness of the piezoelectric vibrating portion 100 at the vibrating body 210 and the thickness of the piezoelectric vibrating portion 100 at the support portion 220 can be made about the same (e.g., the difference between the thicknesses can be 6 μm or less or 3 μm or less). Due to this, when the piezoelectric drive device 10 is configured by stacking a plurality of piezoelectric vibrating portions 100, a gap between two adjacent piezoelectric vibrating portions 100 on the vibrating body 210 and a gap between two adjacent piezoelectric vibrating portions 100 on the support portion 220 can be made about the same. Therefore, rattling between the piezoelectric vibrating portions 100 is less likely to occur. The first electrode 130, the piezoelectric body 140, and the second electrode 150 on the fixed portion 221 preferably do not constitute an operable piezoelectric element. If they do not constitute an operable piezoelectric element, the piezoelectric body 140 is not deformed, and therefore, the fixed portion 221 is easily fixed to another member. In the embodiment, as will be described later, a voltage is applied via the wiring electrode 250 to the first electrode 130 and the second electrode 150 on the vibrating body 210. In order not to constitute an operable piezoelectric element, at least one of the following ways may be employed: (i) the first electrode 130 and the second electrode 150 on the fixed portion 221 are not connected with the wiring electrode 250 for applying a voltage to the first electrode 130 and the second electrode 150 on the vibrating body 210; and (ii) the first electrode 130 on the fixed portion 221 and the second electrode 150 above the fixed portion 221 are connected to each other. The electrodes 130 and 150 on the fixed portion 221 and the electrodes 130 and 150 on the vibrating body 210 are not connected to each other, and are separated from each other. In the above description, the first electrode 130, the piezoelectric body 140, and the second electrode 150 are formed on the support portion 220 (the fixed portion 221 and the connecting portions 222 and 223); however, a configuration may be employed in which the first electrode 130, the piezoelectric body 140, and the second electrode 150 are not formed on the connecting portions 222 and 223 in the support portion 220.

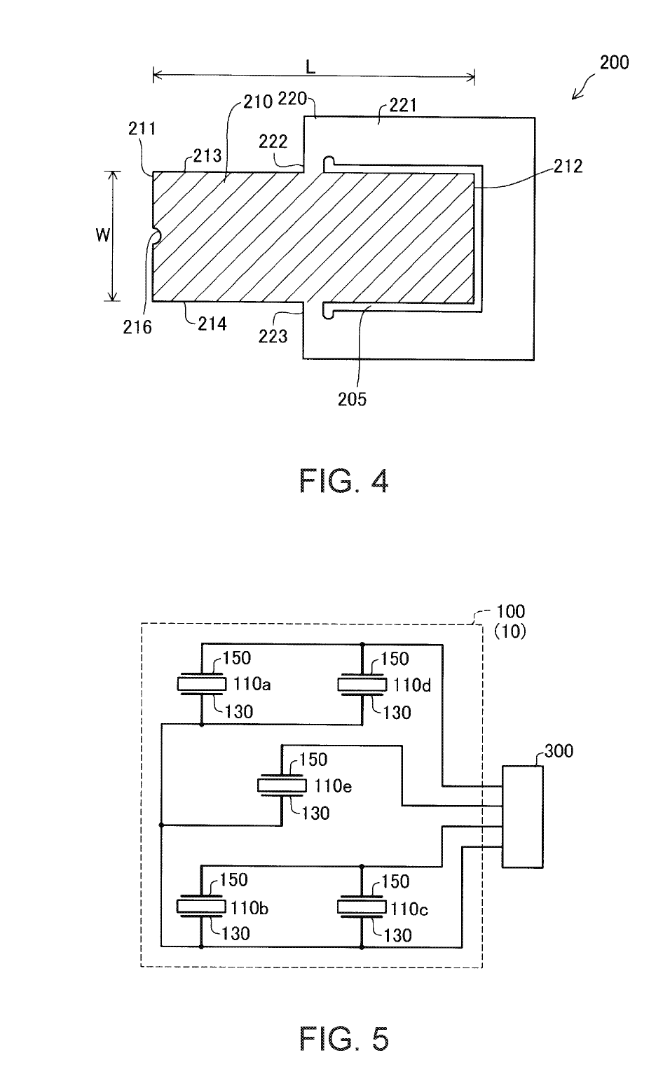

FIG. 4 is a plan view showing the substrate 200. The substrate 200 includes the vibrating body 210 and the support portion 220 (the fixed portion 221 and the connecting portions 222 and 223). In FIG. 4, in order to make it easier to distinguish the vibrating body 210 from the support portion 220, the vibrating body 210 is hatched while the support portion 220 (the fixed portion 221 and the connecting portions 222 and 223) is not hatched. The vibrating body 210 has a rectangular shape including four sides, a first side 211, a second side 212, a third side 213, and a fourth side 214. The first side 211 and the second side 212 are opposed to each other, while the third side 213 and the fourth side 214 are opposed to each other. The third side 213 and the fourth side 214 are each connected between the first side 211 and the second side 212, and longer than the first side. The two connecting portions 222 and 223 are provided respectively at the edge portions of the fixed portion 221, and connected to the middle positions of the third side 213 and the fourth side 214, respectively, of the vibrating body 210. The fixed portion 221 is disposed on the side closer to the second side 212 than the first side 211 so as to turn around the second side 212 side from the first connecting portion 222 to the second connecting portion 223. The vibrating body 210 and the support portion 220 are integrally formed from one silicon substrate. Specifically, by etching a silicon substrate on which the piezoelectric element 110 is formed, the shape of an individual substrate 200 is formed, and at the same time, a gap 205 between the vibrating body 210 and the support portion 220 is formed. Due to this, the vibrating body 210 and the support portion 220 (the fixed portion 221 and the connecting portions 222 and 223) are integrally formed.

The ratio of a length L (length of the third side 213 and the fourth side 214) to a width W (length of the first side 211 and the second side 212) of the vibrating body 210 is preferably L:W=about 7:2. This ratio is a preferable value for the vibrating body 210 to perform ultrasonic vibration (described later) in which the vibrating body 210 flexes from side to side along the plane thereof. The length L of the vibrating body 210 can be, for example, in the range of from 0.1 to 30 mm, while the width W can be, for example, in the range of from 0.02 to 9 mm. In order for the vibrating body 210 to perform the ultrasonic vibration, the length L is preferably 50 mm or less.

A recess 216 is formed at the first side 211 of the vibrating body 210. A contact 20 capable of contacting a driven member is fitted into and joined to (usually bonded to) the recess 216. The contact 20 is a member that contacts the driven member to provide power to the driven member. The contact 20 is preferably formed of a material having durability, such as ceramics (e.g., Al₂O₃).

FIG. 5 is an explanatory view showing an equivalent circuit of the piezoelectric drive device 10. In FIG. 5, for convenience of illustration, a drive circuit 300 and one piezoelectric vibrating portion 100 are described. When the piezoelectric drive device 10 includes a plurality of piezoelectric vibrating portions 100, the plurality of piezoelectric vibrating portions 100 can be connected in parallel with respect to the drive circuit 300. The piezoelectric elements 110 are divided into three groups. A first group includes two piezoelectric elements 110a and 110d. A second group includes two piezoelectric elements 110b and 110c. A third group includes only one piezoelectric element 110e. The piezoelectric elements 110a and 110d of the first group are connected in parallel with each other, and connected to the drive circuit 300. The piezoelectric elements 110b and 110c of the second group are connected in parallel with each other, and connected to the drive circuit 300. The piezoelectric element 110e of the third group is singly connected to the drive circuit 300.

The drive circuit 300 applies a periodically changing AC voltage or pulsating voltage between the first electrode 130 and the second electrode 150 of predetermined piezoelectric elements of the five piezoelectric elements 110a to 110e, for example, the piezoelectric elements 110a and 110d of the first group, and thereby ultrasonically vibrates the piezoelectric vibrating portion 100, so that a rotor (driven body or driven member) that contacts the contact 20 can be rotated in a predetermined rotational direction. Here, the “pulsating voltage” means a voltage obtained by adding a DC offset to an AC voltage, in which the direction of the voltage (electric field) of the pulsating voltage is one direction from one of the electrodes toward the other electrode. The direction of a current is preferably from the second electrode 150 toward the first electrode 130 rather than from the first electrode 130 toward the second electrode 150. Moreover, by applying the AC voltage or pulsating voltage between the first electrode 130 and the second electrode 150 of the piezoelectric elements 110b and 110c of the second group, the rotor contacting the contact 20 can be rotated in the opposite direction.

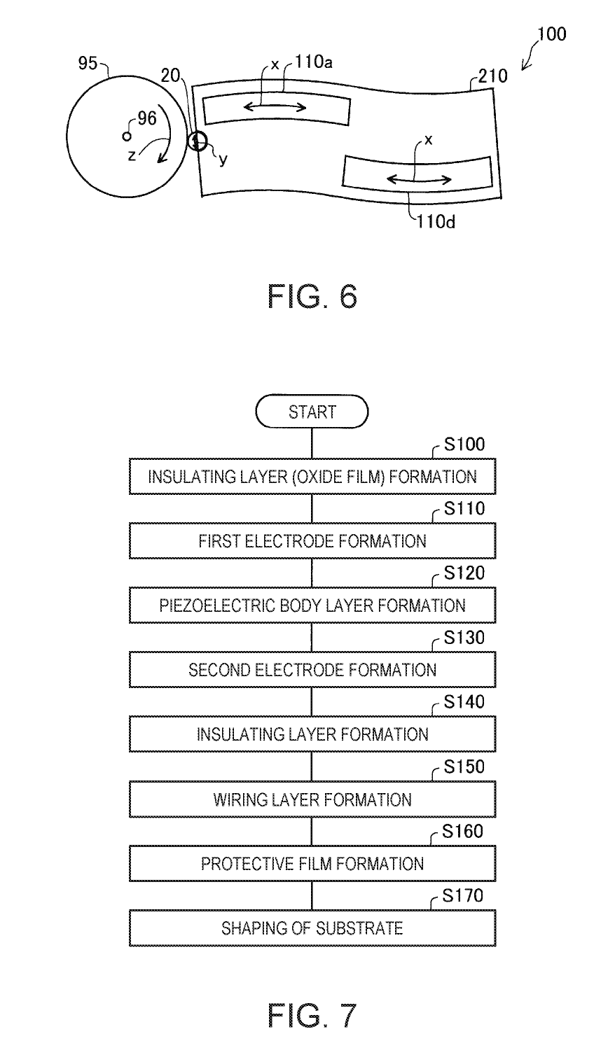

FIG. 6 is an explanatory view showing an example of the operation of the piezoelectric vibrating portion 100. The contact 20 of the piezoelectric vibrating portion 100 is in contact with the perimeter of a rotor 95 as a driven member. In the example shown in FIG. 6, the AC voltage or pulsating voltage is applied to the two piezoelectric elements 110a and 110d, and the piezoelectric elements 110a and 110d expand or contract in the direction of an arrow x in FIG. 6. In response to the expansion or contraction, the vibrating body 210 of the piezoelectric vibrating portion 100 flexes in the plane of the vibrating body 210 and is deformed in a serpentine shape (S-shape), so that the tip of the contact 20 performs a reciprocating motion in the direction of an arrow y, or performs an elliptical motion. As a result, the rotor 95 rotates in a predetermined direction z (clockwise direction in FIG. 6) about a center 96 thereof. When the drive circuit 300 applies the AC voltage or pulsating voltage to the two piezoelectric elements 110b and 110c, the rotor 95 rotates in the opposite direction. When the AC voltage or pulsating voltage is applied to the piezoelectric element 110e in the middle, the piezoelectric drive device 10 expands or contracts in the longitudinal direction, and therefore, power provided from the contact 20 to the rotor 95 can be made larger. The above-described operation of the piezoelectric drive device 10 (or the piezoelectric vibrating portion 100) is described in JP-A-2004-320979 or corresponding U.S. Pat. No. 7,224,102, the disclosure content of which is incorporated herein by reference.

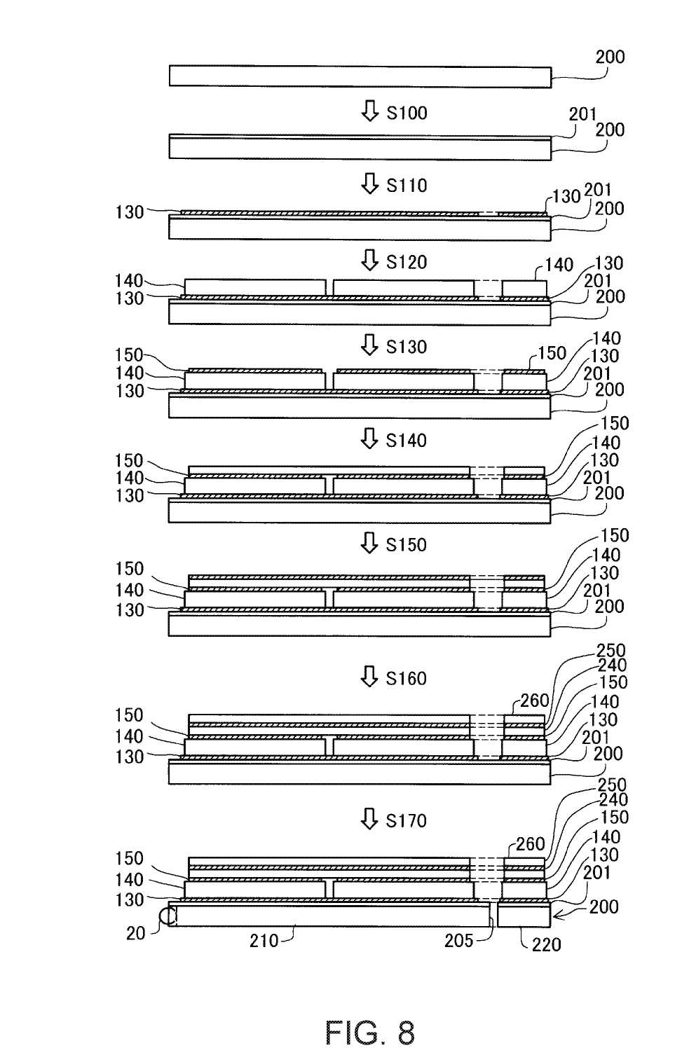

FIG. 7 is an explanatory view showing a flowchart showing a film forming process performed in the manufacturing process of the piezoelectric vibrating portion 100. FIG. 8 is an explanatory view illustrating the manufacturing process of the piezoelectric vibrating portion 100. In Step S100, an insulating layer 201 is formed on the substrate 200. As the substrate 200, for example, a Si wafer can be used. A plurality of piezoelectric vibrating portions 100 can be formed on one Si wafer. As the insulating layer 201, for example, a SiO₂ layer that is formed by thermally oxidizing the surface of the substrate 200 can be used. In FIGS. 3A and 3B, the insulating layer 201 is omitted. In addition, alumina (Al₂O₃) or an organic material such as acrylic resin or polyimide can be used as the insulating layer 201. When the substrate 200 is an insulator, the process for forming the insulating layer 201 can be omitted.

In Step S110, the first electrode 130 is formed and patterned. The first electrode 130 can be formed by, for example, sputtering, and the patterning can be performed by etching.

In Step S120, the piezoelectric body 140 is formed on the first electrode 130, and patterned. The formation of the piezoelectric body 140 can be performed using, for example, a sol-gel method. That is, by dropping a sol-gel solution of a piezoelectric body material on the substrate 200 (the first electrode 130) and rotating the substrate 200 at a high speed, a thin film of the sol-gel solution is formed on the first electrode 130. Thereafter, the thin film is calcined at a temperature of from 200 to 300° C. to form a first layer of the piezoelectric body material on the first electrode 130. Thereafter, by repeating a cycle of dropping of the sol-gel solution, high-speed rotation, and calcination multiple times, a piezoelectric body layer is formed to a desired thickness on the first electrode 130. The thickness of one piezoelectric body layer formed in one cycle is about from 50 to 150 nm although it depends on the viscosity of the sol-gel solution or the rotational speed of the substrate 200. After the piezoelectric body layer is formed to the desired thickness, the piezoelectric body layer is sintered at a temperature of from 600 to 1000° C. to thereby form the piezoelectric body 140. When the thickness of the piezoelectric body 140 after sintering is from 50 nm (0.05 μm) to 20 μm, the piezoelectric drive device 10 having a small size can be realized. When the thickness of the piezoelectric body 140 is 0.05 μm or more, sufficiently large power can be generated in response to expansion or contraction of the piezoelectric body 140. When the thickness of the piezoelectric body 140 is 20 μm or less, sufficiently large power can be generated even if a voltage to be applied to the piezoelectric body 140 is 600V or less. As a result, the drive circuit 300 for driving the piezoelectric drive device 10 can be composed of inexpensive elements. The thickness of the piezoelectric body may be 400 nm or more, in which case the power generated by the piezoelectric element can be made large. The temperature or time for calcination or sintering is an example, and appropriately selected depending on the piezoelectric body material.

When the thin film of the piezoelectric body material is formed and then sintered using the sol-gel method, there are advantages that (a) it is easy to form a thin film, that (b) crystallization with lattice directions aligned is easily made, and that (c) the breakdown voltage of the piezoelectric body can be improved, compared with a related-art sintering method in which raw material powders are mixed and sintered.

In the embodiment, in Step S120, the patterning of the piezoelectric body 140 is performed by ion milling using argon ion beams. Instead of performing the patterning using ion milling, the patterning may be performed by any other patterning method (e.g., dry etching using a chlorine-based gas).

In Step S130, the second electrode 150 is formed on the piezoelectric body 140, and patterned. The formation and patterning of the second electrode 150 can be performed by sputtering and etching similarly to the first electrode 130.

In Step S140, the insulating layer 240 is formed on the second electrode 150. In Step S150, the wiring electrode 250 is formed on the insulating layer 240.

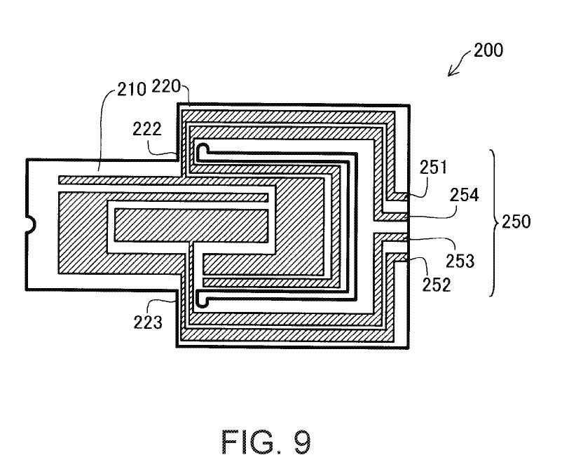

FIG. 9 is an explanatory view showing patterns of the wiring electrode 250. The wiring electrode 250 includes four wiring patterns 251, 252, 253, and 254. These wiring patterns 251 to 254 are formed from above the fixed portion 221 through above the connecting portions 222 and 223 to above the vibrating body 210. The first wiring pattern 251 is connected, above the vibrating body 210, with the second electrodes 150 of the piezoelectric elements 110a and 110d (FIG. 3A). Similarly, the second wiring pattern 252 is connected, above the vibrating body 210, with the second electrodes 150 of the piezoelectric elements 110b and 110c; the third wiring pattern 253 is connected, above the vibrating body 210, with the second electrode 150 of the piezoelectric element 110e; and the fourth wiring pattern 254 is connected, above the vibrating body 210, with the first electrodes 130 of the piezoelectric elements 110a, 110b, 110c, 110d, and 110e. Moreover, these wiring patterns 251 to 254 are connected, above the support portion 220 (except above the connecting portions 222 and 223), with a wiring of the flexible substrate 90 (FIGS. 1 and 2). The wiring of the flexible substrate 90 is connected to the drive circuit 300 (FIG. 5). The wiring patterns 251 to 254 are not connected with the first electrode 130 and the second electrode 150 on the fixed portion 221.

In Step S160, the protective film 260 is formed. In Step S170, the shape of the individual substrate 200 is formed by etching; and at the same time, the gap 205 is formed between the vibrating body 210 and the support portion 220, and the recess 216 is formed at the first side 211. The contact 20 is bonded to the recess 216 with adhesive.

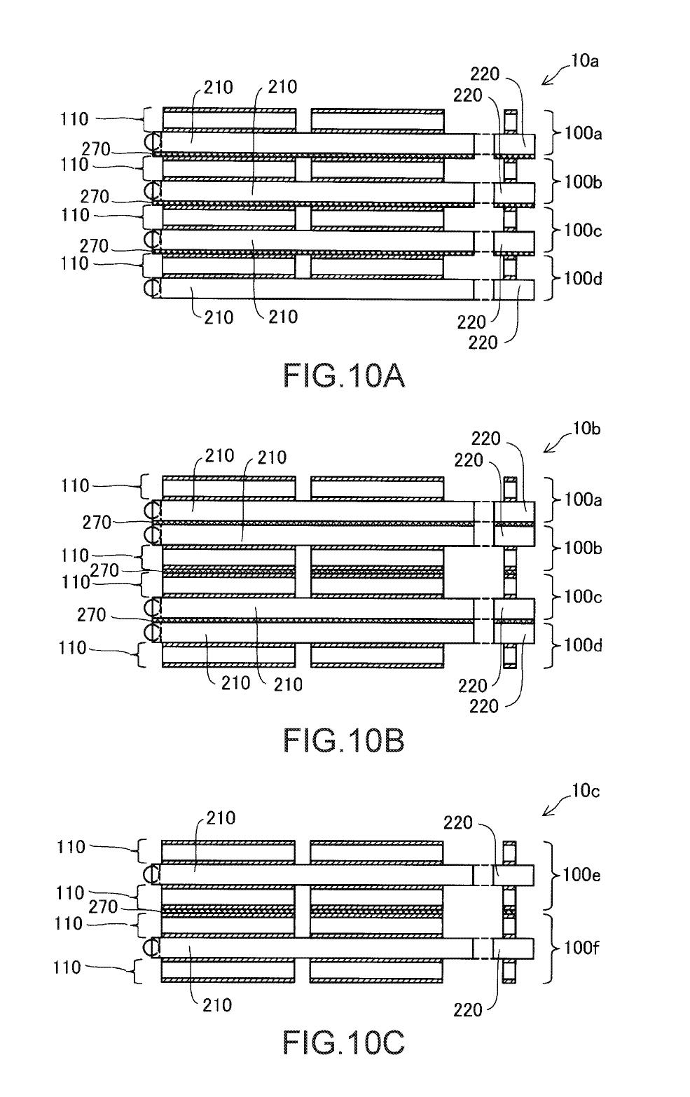

FIGS. 10A to 10C are explanatory views each showing a configuration example in which a plurality of piezoelectric vibrating portions 100 are stacked. In the piezoelectric drive device 10 of the embodiment, the plurality of piezoelectric vibrating portions 100 are stacked in the normal direction of the substrate 200, and used. A piezoelectric drive device 10a shown in FIG. 10A includes four piezoelectric vibrating portions 100a, 100b, 100c, and 100d. Each of the piezoelectric vibrating portions 100a to 100d includes the vibrating body 210 and the support portion 220, similarly to the piezoelectric vibrating portion 100 described above. The support portion of the second piezoelectric vibrating portion 100b is referred to as “second support portion”. The same applies to the third piezoelectric vibrating portion 100c and the fourth piezoelectric vibrating portion 100d. In this example, the vibrating body 210 of the first piezoelectric vibrating portion 100a and the piezoelectric element 110 (second piezoelectric element) of the second piezoelectric vibrating portion 100b adjacent to the first piezoelectric vibrating portion 100a are bonded together with an adhesive layer 270.

Similarly, a piezoelectric drive device 10b shown in FIG. 10B includes four piezoelectric vibrating portions 100a, 100b, 100c, and 100d. However, in FIG. 10B, the vibrating body 210 of the first piezoelectric vibrating portion 100a and the vibrating body 210 (also referred to as “second vibrating body 210”) of the second piezoelectric vibrating portion 100b adjacent to the first piezoelectric vibrating portion 100a are bonded together with an adhesive layer 270, while the piezoelectric element 110 of the second piezoelectric vibrating portion 100b and the piezoelectric element 110 of the third piezoelectric vibrating portion 100c adjacent to the second piezoelectric vibrating portion 100b are bonded together with an adhesive layer 270.

A piezoelectric drive device 10c shown in FIG. 10C includes two piezoelectric vibrating portions 100e and 100f. These piezoelectric vibrating portions 100e and 100f are each configured to include the piezoelectric element 110 on both surfaces of the vibrating body 210. The piezoelectric element 110 of the first piezoelectric vibrating portion 100e and the piezoelectric element 110 of the second piezoelectric vibrating portion 100f adjacent to the first piezoelectric vibrating portion 100e are bonded together with an adhesive layer 270.

Hereinafter, the members constituting the piezoelectric drive device 10 will be described.

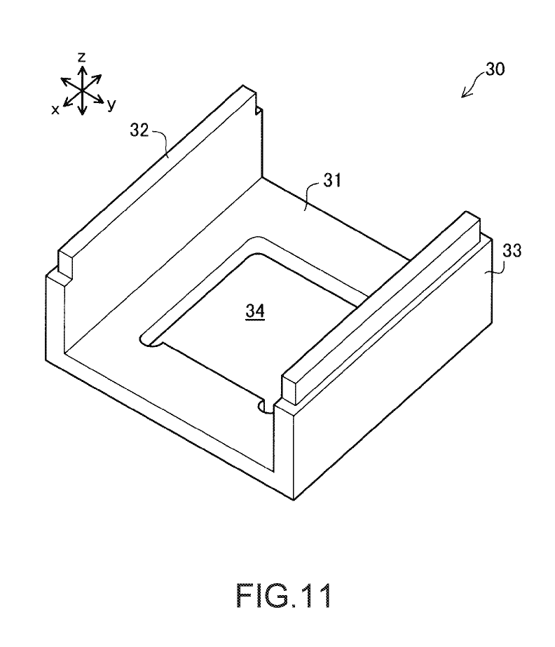

FIG. 11 is an explanatory view showing a configuration of the outer frame 30. The outer frame 30 is formed of resin or metal, and functions as a housing of the piezoelectric drive device 10. The outer frame 30 includes a bottom face portion 31 and side face portions 32 and 33. The bottom face portion 31 has a flat-plate shape, and includes an opening 34 substantially in the central portion. The side face portions 32 and 33 are provided respectively at two edge portions of the bottom face portion 31 in the y direction, and are perpendicular to the bottom face portion 31. In the configuration shown in FIG. 11, the side face portion is not provided at edge portions of the bottom face portion 31 in the x direction; however, a configuration of including the side face portion at one edge portion of the bottom face portion 31 in the x direction may be employed. The side face portion is not necessary at the other edge portion of the bottom face portion 31 in the x direction because the vibrating body 210 of the piezoelectric vibrating portion 100 projects from the other edge portion.

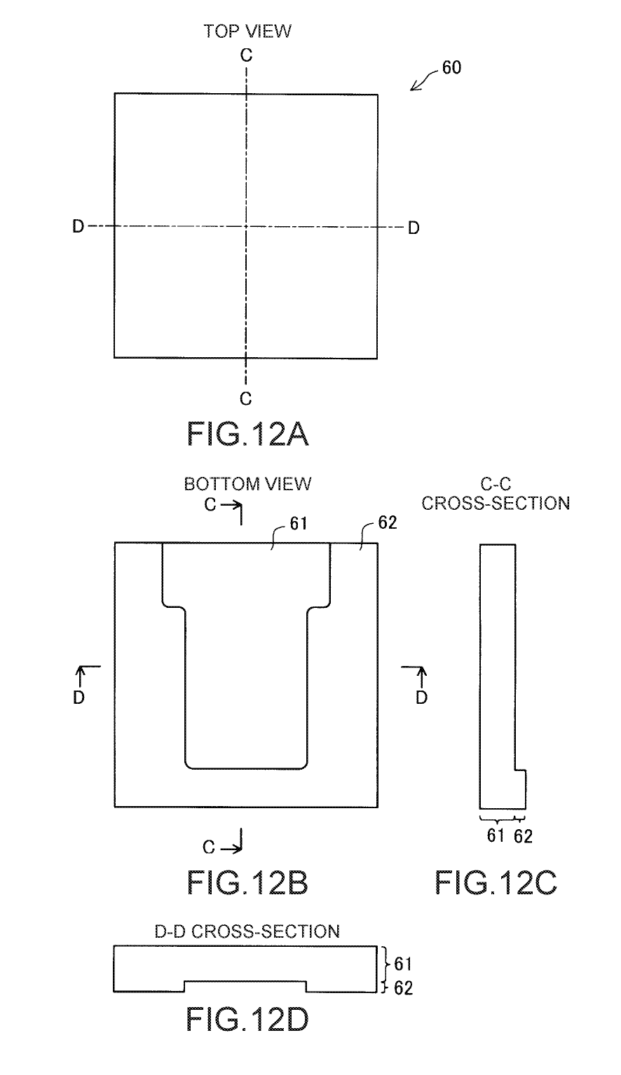

FIGS. 12A to 12D are explanatory views showing a configuration of the intermediate member 60. The intermediate member 60 is a flat-plate shaped member formed of, for example, stainless steel (a thermal conductivity of about 17 to 20 W/mK) or silicon (a thermal conductivity of about 170 W/mK), and includes a flat-plate portion 61 and a projecting portion 62. The projecting portion 62 is provided on the outer edge of one surface of the flat-plate portion 61, specifically at both edge portions of the intermediate member 60 in the y direction and one edge portion in the x direction, but is not provided from the center to the other edge portion in the x direction. Moreover, the projecting portion 62 is not provided on the other surface of the flat-plate portion 61. Expressed in another way, the intermediate member 60 has a structure in which a recess is formed in one surface of a flat plate from the center of the flat plate toward one side. With this structure, the intermediate member 60 is in contact with the support portion 220 or the piezoelectric element 110 on the support portion 220, but is not in contact with the vibrating body 210 or the piezoelectric element 110 on the vibrating body 210. Therefore, the intermediate member 60 does not inhibit vibration of the vibrating body 210. When the piezoelectric drive device 10 is configured by stacking the members as shown in FIG. 2, the intermediate member 60 is disposed with the projecting portion 62 located on the piezoelectric vibrating portion 100 side. As a result, the projecting portion 62 is in contact with the support portion 220 of the piezoelectric vibrating portion 100, while the flat-plate portion 61 is in surface-to-surface contact with the plate spring 50. In the case of this structure, the heat generated from the piezoelectric vibrating portion 100 can move from the projecting portion 62 to the flat-plate portion 61, and move from the flat-plate portion 61 to the plate spring 50.

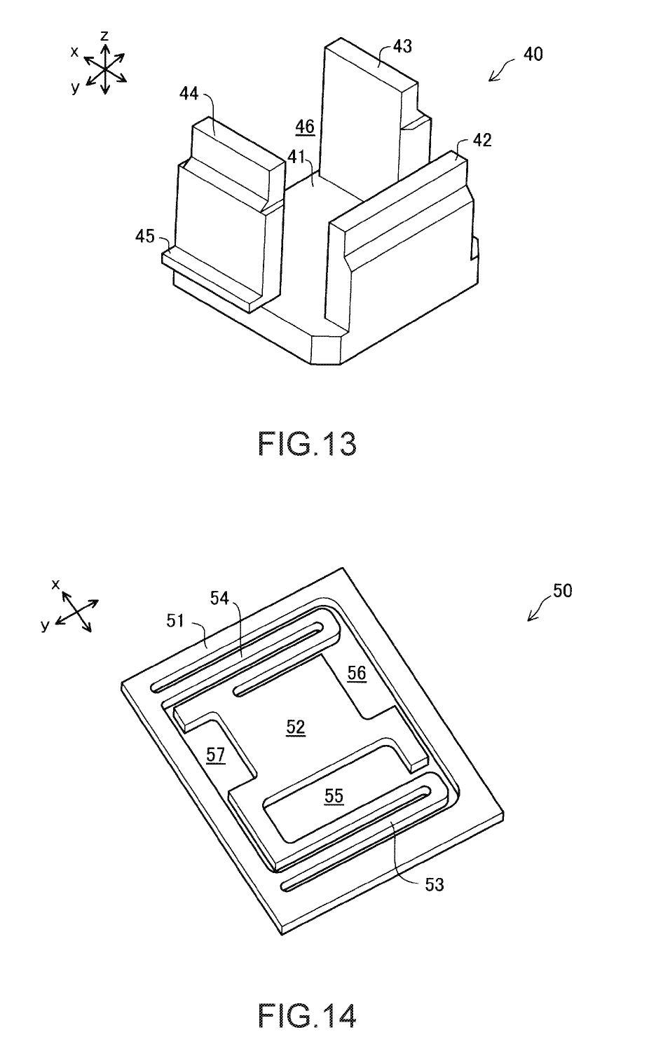

FIG. 13 is an explanatory view showing a configuration of the inner frame 40. The inner frame 40 is formed of resin or metal, and includes a bottom face portion 41 that is a flat plate and the three side face portions 42, 43, and 44. The side face portion 42 is provided at one edge portion of the bottom face portion 41 in the x direction, and is perpendicular to the bottom face portion 41. The side face portions 43 and 44 are provided respectively at two edge portions of the bottom face portion 41 in the y direction, and are perpendicular to the bottom face portion 41. The side face portions 43 and 44 each include a flange 45 at the boundary between the bottom face portion 41 and the side face portions 43 and 44. When the inner frame 40 is disposed in the outer frame 30, the bottom face portion 41 of the inner frame 40 is fitted into the opening 34 (FIG. 11) of the outer frame 30. The flanges 45 support the inner frame 40 so that the inner frame 40 does not fall in the z direction of the outer frame 30. In a substantially rectangular parallelepiped region 46 surrounded by the bottom face portion 41 and the three side face portions 42, 43, and 44 of the inner frame 40, halves of the piezoelectric vibrating portions 100 and the intermediate members 60 disposed on both sides of the piezoelectric vibrating portions 100 are accommodated.

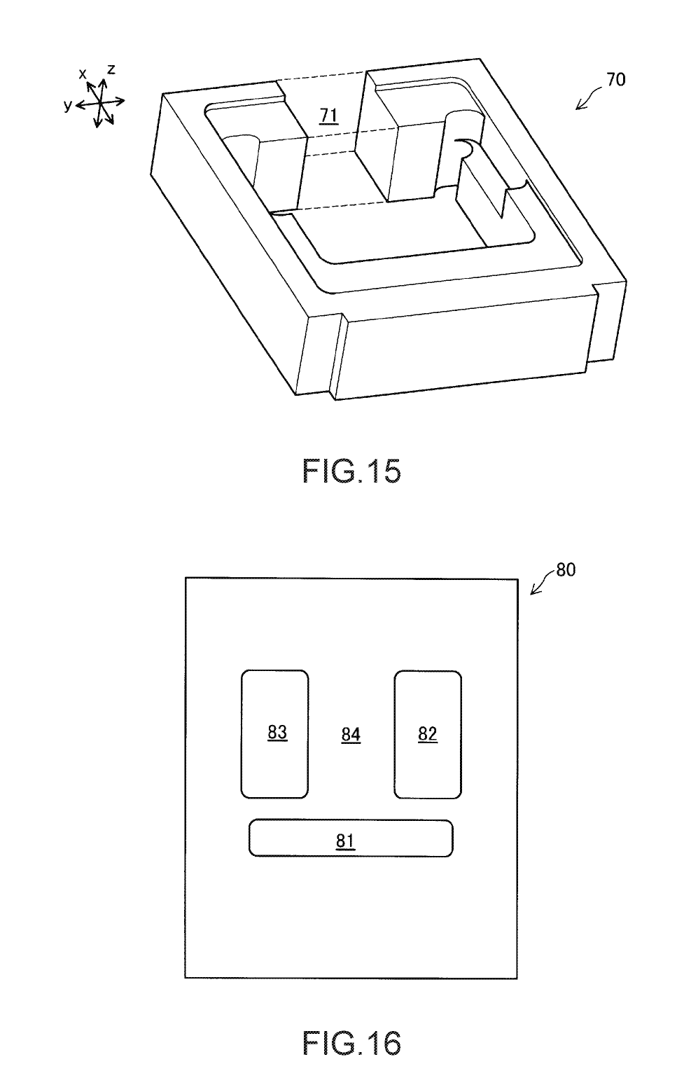

FIG. 14 is an explanatory view showing a configuration of the plate spring 50. The plate spring 50 is a plate-shaped elastic member formed of metal, and includes an outer frame portion 51, a central portion 52, spring portions 53 and 54, and three openings 55, 56, and 57. The outer frame portion 51 is a portion that is located on the outer edge of the plate spring 50 and has a picture-frame shape. The central portion 52 is a portion that is provided in the center of the plate spring 50 and has a rectangular shape. The central portion 52 has a size almost the same as the size of the intermediate member 60. Moreover, the central portion 52 is located at a position where the central portion 52 is in surface-to-surface contact with the intermediate member 60 when the intermediate member 60 and the plate spring 50 are stacked. In the plate spring 50, heat can be easily moved from the surface in contact with at least one of the piezoelectric element 110 and the vibrating body 210 to the surface (surface on the lid 80 (FIG. 2) side) on the opposite side.

The spring portions 53 and 54 are long and narrow portions that connect the central portion 52 with the outer frame portion 51, and have a flexible structure. When the piezoelectric vibrating portion 100 is driven, the vibrating body 210 expands or contracts. When the vibrating body 210 expands, the support portion 220 moves in the direction opposite to the recess 216. Therefore, the intermediate member 60 and the central portion 52 of the plate spring 50 also move in the same direction. As a result, the relative positions of the central portion 52 and the outer frame portion 51 are changed, which causes strain in the spring portions 53 and 54. The spring portions 53 and 54 strained function as springs (elastic bodies), and press the vibrating body 210 against the driven member 95 (FIG. 6).

The three openings 55, 56, and 57 are located at positions corresponding to the three side face portions 42, 43, and 44, respectively, of the inner frame 40. When the piezoelectric drive device 10 is configured by stacking the members, the three side face portions 42, 43, and 44 of the inner frame 40 penetrate through the openings 55, 56, and 57, respectively.

FIG. 15 is an explanatory view showing a configuration of the fixing frame 70. The fixing frame 70 is formed of resin or metal. The fixing frame 70 is a member having a substantially picture-frame shape, and an opening 71 is provided in the middle of one side of the picture-frame shape. The inner frame 40, the piezoelectric vibrating portions 100, and the intermediate members 60 are accommodated in the interior of the fixing frame 70. A portion of the vibrating body 210 of each of the piezoelectric vibrating portions 100 projects through the opening 71 to the outside. When the piezoelectric drive device 10 is configured, the plate springs 50 are disposed on and below the fixing frame 70 as shown in FIG. 2.

FIG. 16 is an explanatory view showing a configuration of the lid 80. The lid 80 is formed of a material having a thermal conductivity of 0.1 W/mK or more, for example, resin or metal. The lid 80 has a function of covering the top of the outer frame 30 as a portion of the housing of the piezoelectric drive device 10, and also has a function as a plate-shaped heat conducting member that dissipates heat. A material having a thermal conductivity of 0.1 W/mK or more enables sufficient heat dissipation, and resin, which is low cost, can be used as a material. The lid 80 may be formed of a material having a thermal conductivity of 10 W/mK or more, for example, stainless steel (a thermal conductivity of about 16 to 20 W/mK). A heat dissipation property can be more enhanced. The material of the lid 80 may be silicon. The thermal conductivity of silicon is about 170 W/mK, so that a heat dissipation property can be further enhanced. The thermal conductivity of the lid 80 may be equal to or more than the thermal conductivity of the plate spring 50 or the intermediate member 60. Since the lid has a higher thermal conductivity than the plate spring 50 or the intermediate member 60, heat is less likely to be trapped in the interior of the piezoelectric drive device 10. The lid 80 includes three openings 81, 82, and 83. The opening 81 is a hole through which the side face portion 42 of the inner frame 40 and the flexible substrate 90 penetrate. The openings 82 and 83 are holes through which the side face portions 43 and 44 of the inner frame penetrate respectively. The central portion 84 surrounded by the three openings 81, 82, and 83 is in surface-to-surface contact with the central portion 52 of the plate spring 50. Therefore, the heat of the plate spring 50 can be quickly moved to the lid 80.

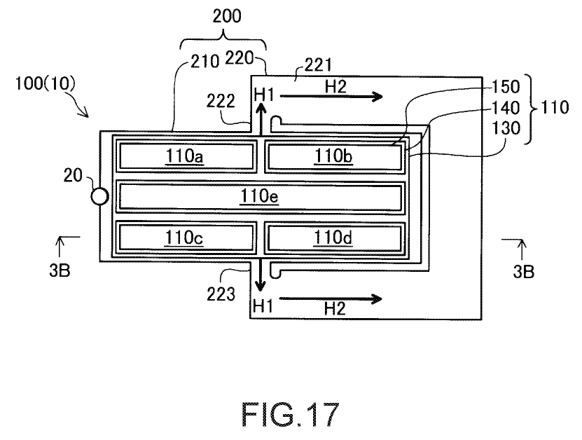

FIG. 17 is an explanatory view showing the movement of heat in the piezoelectric vibrating portion 100. Heat is generated in the piezoelectric elements 110a to 110e. The heat moves from the piezoelectric elements 110a to 110e to the vibrating body 210, moves from the vibrating body 210 through the connecting portions 222 and 223 to the fixed portion 221 as shown by arrows H1, and diffuses into the fixed portion 221 as further shown by arrows H2. In the embodiment, since the vibrating body 210 and the support portion 220 are formed integrally from the same material (e.g., silicon), it is easy for the heat to move to the support portion 220 (the fixed portion 221). Moreover, when the vibrating body 210 and the support portion 220 are formed of silicon, it is easy for the heat to move because silicon has a thermal conductivity of about 170 W/mK, which is extremely large.

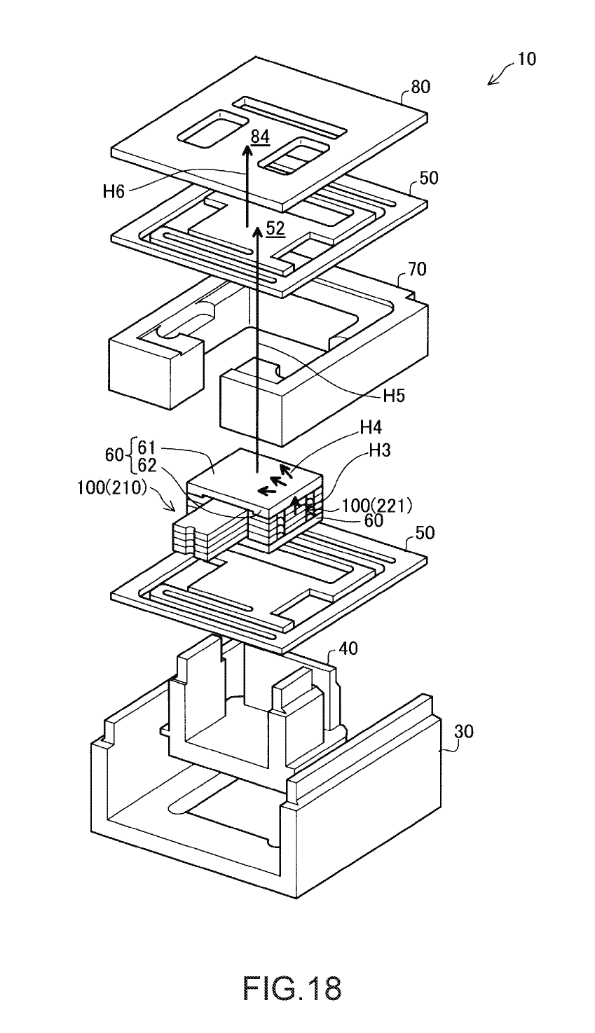

FIG. 18 is an explanatory view showing the movement of heat in the piezoelectric drive device 10. The heat moved to the fixed portion 221 passes through the projecting portion 62 of the intermediate member 60 and moves to the flat-plate portion 61 of the intermediate member 60 like an arrow H3. Further, the heat diffuses into the flat-plate portion 61 as shown by an arrow H4. Since the flat-plate portion 61 of the intermediate member 60 and the central portion 52 of the plate spring 50 are in surface-to-surface contact with each other, the heat moves to the plate spring 50 as shown by an arrow H5. Since the central portion 52 of the plate spring 50 and the central portion 84 of the lid 80 are in surface-to-surface contact with each other, the heat moves to the lid 80 as shown by an arrow H6, and is dissipated through the lid 80 into outside air.

According to the embodiment as described above, the vibrating body 210, the piezoelectric element 110 disposed on at least one surface of the vibrating body 210, the support portion 220 (support portion) supporting the vibrating body 210, the plate spring 50, which is an elastic member that presses the vibrating body 210 against a driven member, and the lid 80, which is a heat conducting member disposed so as to be capable of changing a mutual positional relationship with the plate spring 50 while maintaining a surface-to-surface contact state therewith, are included. Therefore, the heat of the piezoelectric drive device 10 can be easily dissipated.

In the embodiment, the intermediate member 60 is provided to bring the plate spring 50 into indirect contact with at least one of the piezoelectric element 110 and the vibrating body 210; however, the plate spring 50 may be brought into direct contact with at least one of the piezoelectric element 110 and the vibrating body 210 without including the intermediate member 60. Since the intermediate member 60 is not included, it is easy to move the heat to the plate spring 50. In this case, similarly to the intermediate member 60 having the structure in which the intermediate member 60 is not in contact with the piezoelectric element 110 on the vibrating body 210, it is preferred to make the thickness of the piezoelectric vibrating portion 100 at the support portion 220 thicker than the thickness of the piezoelectric vibrating portion 100 at the vibrating body 210 or to thicken the outer frame portion 51 of the plate spring 50 on the piezoelectric vibrating portion 100 side so that the plate spring 50 and the piezoelectric element 110 on the vibrating body 210 do not contact each other.

### MODIFIED EXAMPLES

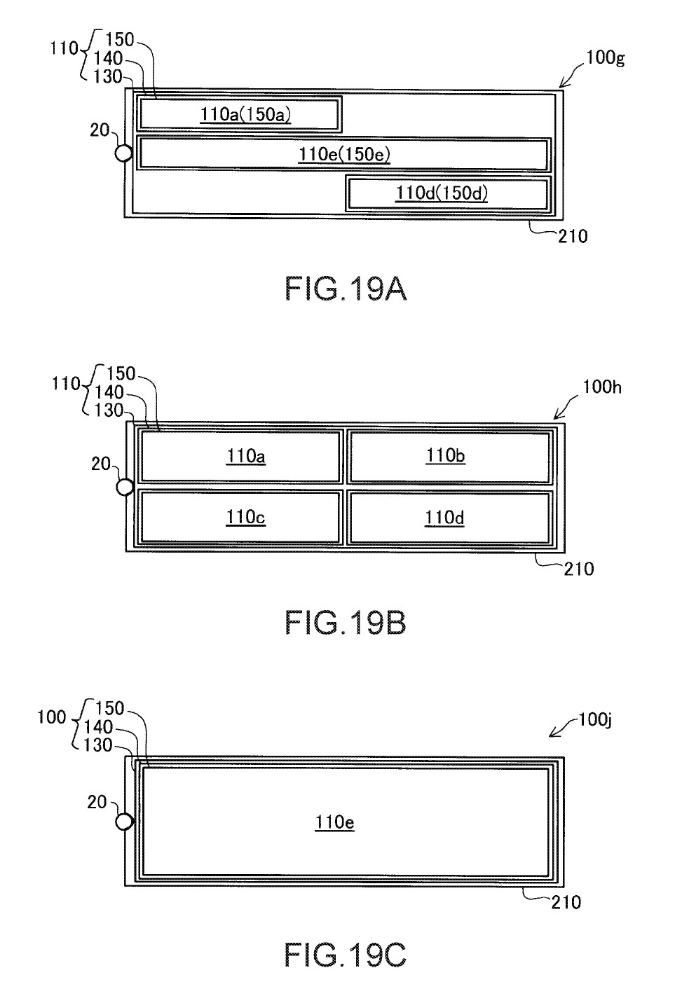

FIGS. 19A to 19C are plan views of the piezoelectric vibrating portion 100 as other embodiments of the invention, corresponding to FIG. 3A of the embodiment. In FIGS. 19A to 19C, for convenience of illustration, only the vibrating body 210 is illustrated, and the support portion 220 and the connecting portions 222 and 223 are omitted. In a piezoelectric vibrating portion 100g of FIG. 19A, a pair of piezoelectric elements 110b and 110c are omitted. The piezoelectric vibrating portion 100g can also rotate the rotor 95 in one direction z shown in FIG. 6. Since the same voltage is applied to three piezoelectric elements 110a, 110e, and 110d in FIG. 19A, second electrodes (150a, 150e, and 150d) of these three piezoelectric elements 110a, 110e, and 110d may be formed as one continuous electrode layer.

FIG. 19B is a plan view of a piezoelectric vibrating portion 100h as still another embodiment of the invention. In the piezoelectric vibrating portion 100h, the piezoelectric element 110e in the middle in FIG. 3A is omitted, and the other four piezoelectric elements 110a, 110b, 110c, and 110d are formed to have an area larger than that in FIG. 3A. The piezoelectric vibrating portion 100h can also achieve almost the same advantageous effects as the first embodiment.

FIG. 19C is a plan view of a piezoelectric vibrating portion 100j as further another embodiment of the invention. In the piezoelectric vibrating portion 100j, the four second electrodes 150a, 150b, 150c, and 150d in FIG. 3A are omitted, and one second electrode 150e is formed to have a large area. The piezoelectric vibrating portion 100j only expands or contracts in the longitudinal direction, but can provide large power from the contact 20 to the driven body (not shown).

As can be seen from FIGS. 3A and 3B and FIGS. 19A to 19C, at least one electrode layer can be provided as the second electrode 150 of the piezoelectric vibrating portion 100. However, when the piezoelectric element 110 (the second electrode 150) is provided in diagonal positions of the vibrating body 210 having a rectangular shape as in the embodiments shown in FIG. 3A and FIGS. 19A and 19B, the provision is preferred because the vibrating body 210 can be deformed in a serpentine shape in which the vibrating body 210 flexes in the plane thereof.

Embodiment of Apparatus using Piezoelectric Drive Device

The piezoelectric drive device 10 described above can provide large power to a driven member by the use of resonance, and can be applied to various apparatuses. The piezoelectric drive device 10 can be used as a drive device in various apparatuses such as, for example, a robot (including an electronic component conveying apparatus (IC handler)), a dosing pump, a calendar drive apparatus of a clock, and a printing apparatus (e.g., a paper feed mechanism; however, a vibrating body is not resonated in a piezoelectric drive device used in a head, and therefore, the piezoelectric drive device cannot be applied to a head). Hereinafter, representative embodiments will be described.

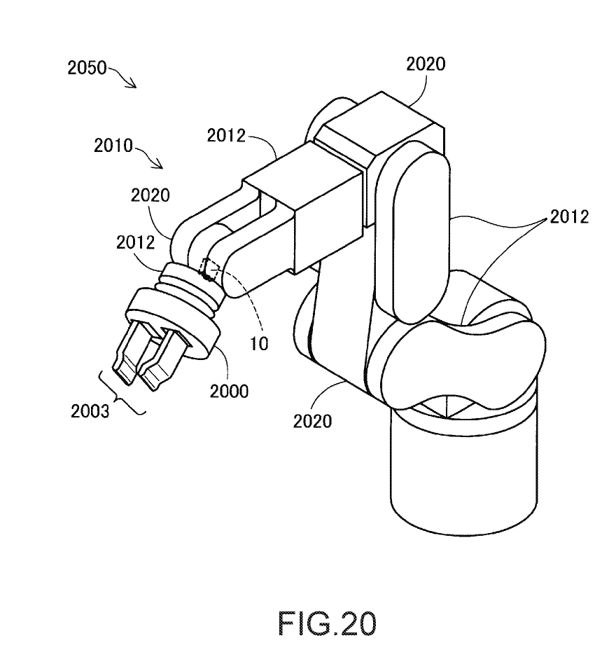

FIG. 20 is an explanatory view showing an example of a robot 2050 using the piezoelectric drive device 10 described above. The robot 2050 includes an arm 2010 (also referred to as “arm portion”) including a plurality of link portions 2012 (also referred to as “link members”) and a plurality of joints 2020 each of which connects the link portions 2012 together in a rotatable or flexible state. The piezoelectric drive device 10 described above is incorporated into each of the joints 2020, so that the joint 2020 can be rotated or flexed by any angle using the piezoelectric drive device 10. A robot hand 2000 is connected to the tip of the arm 2010. The robot hand 2000 includes a pair of gripping portions 2003. The piezoelectric drive device 10 is also incorporated into the robot hand 2000, so that an object can be gripped by opening and closing the gripping portions 2003 using the piezoelectric drive device 10. Moreover, the piezoelectric drive device 10 is provided also between the robot hand 2000 and the arm 2010, so that the robot hand 2000 can be rotated with respect to the arm 2010 using the piezoelectric drive device 10.

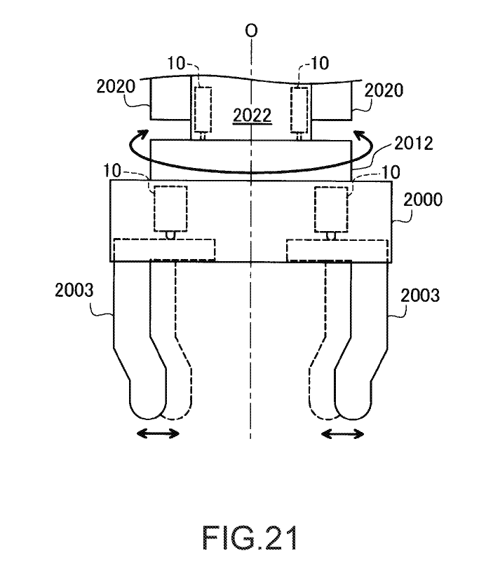

FIG. 21 is an explanatory view of a wrist portion of the robot 2050 shown in FIG. 20. The joints 2020 of the wrist interpose a wrist rotating portion 2022, and the link portion 2012 of the wrist is attached to the wrist rotating portion 2022 rotatable about a central axis 0 of the wrist rotating portion 2022. The wrist rotating portion 2022 includes the piezoelectric drive device 10, so that the piezoelectric drive device 10 rotates the link portion 2012 of the wrist and the robot hand 2000 about the central axis O. The plurality of gripping portions 2003 are erected on the robot hand 2000. The proximal end portion of the gripping portion 2003 can move in the robot hand 2000, and the piezoelectric drive device 10 is mounted on the base portion of the gripping portions 2003. For this reason, by operating the piezoelectric drive device 10, the gripping portions 2003 can be moved to grip a target object.

The robot is not limited to a single-arm robot, and the piezoelectric drive device 10 can also be applied to a multi-arm robot having two or more arms. Here, in addition to the piezoelectric drive device 10, an electric power line for supplying electric power to various devices such as a force sensor or a gyro sensor, or a signal line for transmitting signals, is included in the interior of the joint 2020 of the wrist or the robot hand 2000, and thus a large number of wirings are necessary. Therefore, it is very difficult to dispose wirings in the interior of the joint 2020 or the robot hand 2000. However, in the piezoelectric drive device 10 of the embodiment described above, a drive current can be made smaller than that of a general electric motor or a related-art piezoelectric drive device, and therefore, wirings can be disposed even in a small space such as the joint 2020 (particularly a joint at the tip of the arm 2010) or the robot hand 2000.

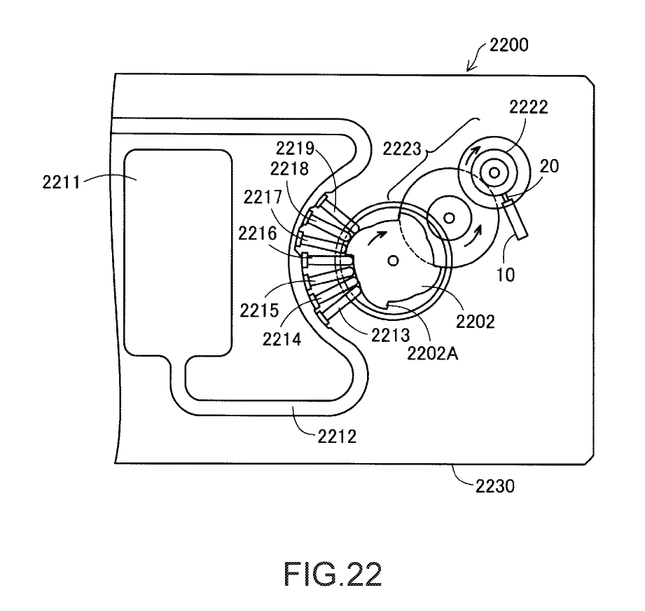

FIG. 22 is an explanatory view showing an example of a liquid feed pump 2200 using the piezoelectric drive device 10 described above. The liquid feed pump 2200 includes, in a case 2230, a reservoir 2211, a tube 2212, the piezoelectric drive device 10, a rotor 2222, a deceleration transmission mechanism 2223, a cam 2202, and a plurality of fingers 2213, 2214, 2215, 2216, 2217, 2218, and 2219. The reservoir 2211 is an accommodating portion for accommodating liquid as a target to be transported. The tube 2212 is a tube for transporting the liquid sent from the reservoir 2211. The contact 20 of the piezoelectric drive device 10 is provided in a state of being pressed against the side surface of the rotor 2222, and the piezoelectric drive device 10 rotationally drives the rotor 2222. The rotational force of the rotor 2222 is transmitted to the cam 2202 via the deceleration transmission mechanism 2223. The fingers 2213 to 2219 are members for blocking the tube 2212. When the cam 2202 rotates, the fingers 2213 to 2219 are sequentially pressed outward in the radial direction by a projecting portion 2202A of the cam 2202. The fingers 2213 to 2219 sequentially block the tube 2212 from the upstream side (the reservoir 2211 side) in the transportation direction. Due to this, the liquid in the tube 2212 is sequentially transmitted to the downstream side. By doing this, it is possible to realize the liquid feed pump 2200 capable of accurately feeding an extremely small amount of liquid and having a small size. The arrangement of each member is not limited to that shown in the drawing. Moreover, a configuration may be employed, in which a member such as the finger is not provided and a ball or the like provided on the rotor 2222 blocks the tube 2212. The liquid feed pump 2200 described above can be used for a dosing apparatus or the like that administers a medicinal solution such as insulin to the human body. Here, by the use of the piezoelectric drive device 10 of the embodiment described above, a drive current becomes smaller than that of a related-art piezoelectric drive device, and therefore, power consumption of the dosing apparatus can be suppressed. Therefore, when the dosing apparatus is driven with a battery, the use of the piezoelectric drive device 10 is particularly effective.

The embodiments of the invention have been described above based on some examples. However, the above embodiments of the invention are for facilitating the understanding of the invention and not for limiting the invention. The invention may be modified or improved without departing from the gist thereof and the scope of the appended claims, and the invention, of course, includes the equivalents of the modification or improvement.

The entire disclosure of Japanese Patent Application No. 2015-136780, filed Jul. 8, 2015 is expressly incorporated by reference herein.

What is claimed is:

1. A piezoelectric drive device comprising:
a piezoelectric vibrating portion including a vibrating body, a piezoelectric element disposed on at least one surface of the vibrating body, and a support portion supporting the vibrating body;
an elastic member pressing the vibrating body against a driven member; and
a heat conducting member disposed so as to be capable of changing a mutual positional relationship with the elastic member while maintaining a surface-to-surface contact state therewith.

2. The piezoelectric drive device according to claim 1, further comprising an intermediate member located between the vibrating body and the elastic member, the intermediate member being in contact with the support portion and not in contact with the piezoelectric element disposed on the vibrating body.

3. The piezoelectric drive device according to claim 1, wherein
the elastic member is in contact with the support portion and not in contact with the piezoelectric element on the vibrating body.

4. The piezoelectric drive device according to claim 1, wherein
the elastic member is in contact with the heat conducting member at a surface on the side opposite to the surface in contact with the piezoelectric vibrating portion.

5. The piezoelectric drive device according to claim 1, further comprising a housing accommodating the vibrating body, the piezoelectric element, the support portion, and the elastic member, wherein
the heat conducting member constitutes a portion of the housing.

6. The piezoelectric drive device according to claim 1, wherein
a thermal conductivity of the heat conducting member is 0.1 W/mK or more.

7. The piezoelectric drive device according to claim 1, wherein
a thermal conductivity of the heat conducting member is 10 W/mK or more.

8. The piezoelectric drive device according to claim 1, wherein
the heat conducting member contains silicon.

9. The piezoelectric drive device according to claim 1, wherein
the vibrating body and the support portion contain the same material and are integrated together.

10. A robot comprising:
a plurality of link portions;
a joint connecting the plurality of link portions together; and
the piezoelectric drive device according to claim 1, which rotates the plurality of link portions with the joint.

11. A method for driving the piezoelectric drive device according to claim 1, comprising applying, to the piezoelectric element, a pulsating voltage that periodically changes and in which a direction of an electric field to be applied to a piezoelectric body of the piezoelectric element is one direction.
